(19) United States
(12) Patent Application Publication
(10) Pub. No.: US 2025/0174662 A1
(43) Pub. Date: May 29, 2025

(54) NON-AQUEOUS SECONDARY BATTERY

(71) Applicant: TOYOTA JIDOSHA KABUSHIKI KAISHA, Toyota-shi (JP)

(72) Inventor: Akira KOHYAMA, Toyoake-shi (JP)

(73) Assignee: TOYOTA JIDOSHA KABUSHIKI KAISHA, Toyota-shi (JP)

(21) Appl. No.: 18/891,317

(22) Filed: Sep. 20, 2024

(30) Foreign Application Priority Data
Nov. 24, 2023 (JP) 2023-199399

(51) Int. Cl. H01M 4/62; H01M 4/02

(52) U.S. Cl. CPC H01M 4/622; H01M 2004/021

(57) ABSTRACT

A non-aqueous secondary battery of the present disclosure includes a cathode, an anode, a separator disposed between the cathode and the anode, and a non-aqueous electrolyte solution. The anode is formed by laminating an anode current collector, a binder layer, and an anode mixture layer in this order. The binder layer contains a conductive aid. The ratio of the average length of the conductive aid to the average thickness of the binder layer is 1.8 or more.

### CROSS-REFERENCE TO RELATED APPLICATION

This application claims priority to Japanese Patent Application No. 2023-199399 filed on Nov. 24, 2023, incorporated herein by reference in its entirety.

### BACKGROUND

### 1. Technical Field

The present disclosure relates to a non-aqueous secondary battery.

### 2. Description of Related Art

A lithium secondary battery using a non-aqueous electrolyte solution (hereinafter also referred to as “non-aqueous secondary battery”) is used in information communication technology (e.g., personal computers and smartphones), in-vehicle equipment, power storage, etc.

Japanese Unexamined Patent Application Publication No. 2004-273181 (JP 2004-273181 A) discloses an electrode plate for a battery. The electrode plate is an electrode plate in which an adhesive layer (hereinafter also referred to as “binder layer”) and an active material layer (hereinafter also referred to as “mixture layer”) are sequentially laminated on at least one surface of a current collector. The binder layer is made of a polyamide-imide resin containing carbon. As carbon, graphite, carbon black, or acetylene black is specifically disclosed.

### SUMMARY

In the electrode body disclosed in JP 2004-273181 A, however, the content of carbon in the binder layer is increased to increase the energy density (specifically, to improve the electron conductivity of the anode). When the content of carbon in the binder layer is increased, the intensity at which the binder layer binds an anode mixture layer to an anode current collector (hereinafter also referred to as “anode binding intensity”) may decrease. Further, there is a demand for a non-aqueous secondary battery in which a decrease in discharge rate characteristic of the non-aqueous secondary battery is suppressed.

The present disclosure has been made in view of the above circumstances. An object of an embodiment of the present disclosure is to provide a non-aqueous secondary battery in which the binding intensity and electron conductivity of an anode are excellent and a decrease in discharge rate characteristic is suppressed.

Means for achieving the above object includes the following aspects.

<1>A non-aqueous secondary battery including
a cathode, an anode, a separator disposed between the cathode and the anode, and a non-aqueous electrolyte solution, in which
the anode is obtained by laminating an anode current collector, a binder layer, and an anode mixture layer in an order of the anode current collector, the binder layer, and the anode mixture layer,
the binder layer contains a conductive aid, and
a ratio (A/B) of an average length (A) of the conductive aid to an average thickness (B) of the binder layer is 1.8 or more.
   <2>The non-aqueous secondary battery according to <1>, in which the ratio (A/B) is 2.5 or more.
   <3>The non-aqueous secondary battery according to <1>or <2>, in which a content of the conductive aid is 0.8% by mass or more with respect to a total amount of the binder layer.
   <4>The non-aqueous secondary battery according to any one of <1>to <3>, in which the binder layer includes a styrene-butadiene copolymer.
   <5>The non-aqueous secondary battery according to any one of <1>to <4>, in which the anode mixture layer has a thickness of 100 μm or more.

The present disclosure provides the non-aqueous secondary battery in which the binding intensity and electron conductivity of the anode are excellent and the decrease in discharge rate characteristic is suppressed.

### DETAILED DESCRIPTION OF EMBODIMENTS

In the present disclosure, a numerical range indicated by using “from” means a range including the numerical values described before and after “from” as the minimum value and the maximum value, respectively. In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples. In the present disclosure, a combination of two or more preferred embodiments is a more preferred embodiment. In the present disclosure, the amount of each component means the total amount of a plurality of substances unless otherwise specified, when a plurality of substances corresponding to each component are present. In the present disclosure, the term “step” is included in the term as long as the intended purpose of the step is achieved, even if it is not clearly distinguishable from other steps as well as independent steps.

### (1) Non-Aqueous Secondary Battery

The non-aqueous secondary battery of the present disclosure includes a cathode, an anode, a separator disposed between the cathode and the anode, and a non-aqueous electrolyte solution. The anode is formed by laminating an anode current collector, a binder layer, and an anode mixture layer in this order. The binder layer contains a conductive aid. The average length (A) of the conductive aid and the average thickness (B) of the binder layers are 1.8 or more in A/B.

Since the non-aqueous secondary battery of the present disclosure has the above-described configuration, the non-aqueous secondary battery is excellent in the binding strength and the electronic conductivity of the anode, and the deterioration of the discharge rate characteristics is suppressed.

This effect is presumed to be due to, but not limited to, the following reasons. In the present disclosure, A/B is 1.8 or more. Thus, conductive paths are easily formed in the binder layer even if the amount of conductive aid in the binder layer is smaller than in the configuration in which the ratio (A/B) is less than 1.8 (for example, the configuration in which the conductive aid is composed of at least one of graphite, carbon black, and acetylene black). As a result, it is presumed that the non-aqueous secondary battery of the present disclosure is excellent in the binding strength and the electron conductivity of the anode, and the deterioration of the discharge rate characteristics is suppressed.

The cell structure of the non-aqueous secondary battery is not particularly limited, and examples thereof include a wound type and a laminated type. The winding type is formed by winding a straight electrode body in which an anode, a separator, and a cathode are laminated in this order. In the laminated type, an anode, a separator, and a single-wafer-shaped electrode body in which cathodes are laminated in this order are laminated.

### (1.1) Anode

The anode is formed by laminating an anode current collector, a binder layer, and an anode mixture layer in this order.

### (1.1.1) Anode Current Collector

The anode current collector may be any known current collector (e.g., copper foil).

### (1.1.2) Binder Layer

A/B of the binder layer is preferably 2.5 or more. Thus, a decrease in discharge rate characteristics of the non-aqueous secondary battery is suppressed. The specific (A/B) may be 4.0 or more, or 5.0 or more. A/B may be equal to or less than 7.0 or equal to or less than 4.0.

The thickness (B) of the binder layer is not particularly limited as long as the ratio (A/B) is 1.8 or more. The thickness (B) of the binder layer may be 3 μm or more, 5 um or more, or 8 μm or more. The thickness (B) of the binder layer may be 13 μm or less, or 8 μm or less. The thickness (B) of the binder layers is measured by electron-microscopy (SEM) observations.

### (1.1.2.1) Conductive Aid

The average length (A) of the electric aid is not particularly limited, and may be 8 μm or more, 13 μm or more, or 20 μm or more. The average length (A) of the conductive aid may be less than or equal to 35 μm. The average length (A) of the conductive aid is determined by electron-microscopy (SEM) observations.

The conductive aid is not particularly limited as long as the ratio (A/B) is 1.8 or more, preferably includes carbon nanotubes, and is preferably a carbon nanotube.

The content of the conductive aid is not particularly limited. The content of the conductive aid may be 0.3% by mass or more, 0.8% by mass or more, or 1.0% by mass or more based on the total amount of the binder layer. The content of the conductive aid may be 2.2% by mass or less, and may be 1.2% by mass or less.

When the ratio (A/B) is 2.5 or more, the content of the conductive aid is preferably 0.8% by mass or more with respect to the total amount of the binder layer. As a result, the penetration resistance of the anode mixture layer becomes lower.

### (1.1.2.2) Binder

The binder layer connects the anode mixture layer and the anode current collector. The binder layer usually further comprises a binder in addition to the conductive aid. Examples of the binder include vinyl halide resins, rubbers, and polyolefin resins. Examples of the vinyl halide include polyvinylidene fluoride (PVdF), a copolymer of polyvinylidene fluoride and hexafluoropropylene (PVdF-HFP), and the like. Examples of the rubber include styrene-butadiene rubber (SBR), butadiene rubber (BR), acrylate butadiene rubber (ABR), acrylonitrile-butadiene rubber (NBR), and butyl rubber (isobutylene-isoprene rubber). Examples of the polyolefin resin include polyethylene and polypropylene. One binder may be used alone, or two or more binders may be used in combination.

When the ratio (A/B) is 2.5 or more and the content of the conductive aid is 0.8% by mass or more, the binder layer preferably contains a styrene-butadiene rubber. As a result, the binding strength of the anode mixture layer is further improved, and the deterioration of the discharge rate characteristics of the non-aqueous secondary battery is further suppressed.

The content of the binder is not particularly limited. The content of the binder may be 99.7% by mass or less, 99.2% by mass or less, or 99.0% by mass or less with respect to the total amount of the binder layer. The content of the conductive aid may be 97.8% by mass or more and 98.8% by mass or more.

### (1.1.2.3) Other Ingredients

25 The binder layer may or may not further comprise other components. Examples of other components include an electrolyte supporting salt (lithium salt), a polymer electrolyte, and an additive (e.g., trifluoropropylene carbonate) for enhancing ion conductivity.

### (1.1.3) Anode Mixture Layer

The anode mixture layer includes an anode layer active material (e.g., carbon (e.g., natural graphite, artificial graphite), a compound capable of alloying with lithium (e.g., silicon, tin, etc.)) capable of absorbing and desorbing charge carriers. The anode mixture layer may further contain, if necessary, a conductive aid (for example, acetylene black or the like) for increasing the electron conductivity, a binder, an electrolyte supporting salt (lithium salt) for increasing the ion conductivity, a polymer electrolyte, and an additive (for example, trifluoropropylene carbonate or the like). Examples of the binder include the same as those exemplified as the binder of the binder layer.

The thickness of the anode mixture layer is not particularly limited, and is preferably 100 μm or more. Thus, the energy density of the non-aqueous secondary battery is improved. From the viewpoint of increasing the energy density, the thickness of the anode mixture layer is more preferably 150 μm or more, and still more preferably 180 μm or more. The thickness of the anode mixture layer may be 250 μm or less.

### (1.2) Cathode

The cathode may include a cathode current collector (for example, an aluminum foil or the like) and a cathode mixture layer. The cathode mixture layer is laminated on at least one main surface of the cathode current collector.

The cathode mixture layer includes a cathode active material. The active cathode material releases lithium ions into or occludes from the non-aqueous electrolyte solution. The cathode active material may be any known cathode active material (e.g., LiNiO_{2,} LiNi_{1/3}CO_{1/3}Mn_{1/3}O₂). The cathode mixture layer may further contain a known conductive material (e.g., carbon black, etc.), trilithium phosphate, a binder. Examples of the binder include the same as those exemplified as the binder of the binder layer.

### (1.3) Separator

The separator maintains a gap between the cathode and the anode to prevent the occurrence of a contact short circuit, and allows lithium ions to pass through the separator. Examples of the separator include a porous resin sheet and a nonwoven fabric. Examples of the material of the porous resin sheet include polyolefins (polypropylene, polyethylene, and the like). Examples of the material of the nonwoven fabric include polypropylene, polyethylene terephthalate, and methylcellulose. The separator may have a known configuration.

### (1.4) Non-Aqueous Electrolyte Solution

The non-aqueous electrolyte solution may include a non-aqueous solvent and a lithium salt. Examples of the lithium salt include LiClO_{4,} LiAsF_{6,} LiPF_{6,} LiBF_{4,} LiCF₃SO_{3,} LiN(FSO₂)_{2,} LiN(CF₃SO₂)_{2.} Examples of the non-aqueous solvent include cyclic carbonates (e.g., ethylene carbonate, etc.), chain carbonates (e.g., dimethyl carbonate, ethyl methyl carbonate, etc.), cyclic esters (e.g., γ-butyrolactone, γ-valerolactone, etc.), chain esters (e.g., methyl formate, methyl acetate, etc.), and ethers (e.g., dimethoxyethane, ethoxymethoxyethane, etc.). The non-aqueous electrolyte solution may contain an additive (for example, vinylene carbonate, lithium bis(oxalato)borate, or the like).

### (1.5) Case

A non-aqueous secondary battery usually has a case. The case contains a cathode, an anode, a separator, and a non-aqueous electrolyte solution. The case is not particularly limited, and examples thereof include a laminate film (for example, an aluminum sheet, etc.), a battery can (for example, a cylindrical shape, a square shape, a coin shape, etc.), and the like.

Hereinafter, the present disclosure will be described in more detail with reference to Examples, but the disclosure of the present disclosure is not limited to these Examples.

### [1] Examples 1 to 11 and Comparative Examples 1 to 11

### [1.1] Cathode

LiNi_{1/3}Co_{1/3}Mn_{1/3}O₂ as the cathode active material, the conductive aid, and the polyvinylidene fluoride (PVdF)-containing solutions as the binder were mixed to prepare a slurry. The mass ratio of the cathode active material, the conductive aid, and the binder (cathode active material: conductive aid: binder) was 87:10:3. A “PVdF containing solution” refers to a mixed solution of PVdF and solvents. The slurry was applied to an aluminum foil as a cathode current collector to obtain a cathode sheet. A cathode was obtained by punching the cathode with a punch of φ 12 (diameter: 12 mm). The cathode is formed by laminating a cathode current collector and a cathode mixture layer in this order.

### [1.2] Anode

### [1.2.1] Binder Layer

As a solution containing a binder (hereinafter, also referred to as a “binder-containing solution”), a styrene-butadiene rubber (SBR)-containing solution and a polyvinylidene fluoride (PVdF)-containing solution were prepared. An “SBR containing solution” refers to a mixed solution of SBR and solvents. A “PVdF containing solution” refers to a mixed solution of PVdF and solvents.

Carbon nanotubes (CNT) with an average length of 10 μm, a CNT with an average length of 15 μm, and a CNT with an average length of 30 μm were prepared as conductive aids.

The binder-containing solution containing the binder shown in Table 1 and the conductive aid shown in Table 1 were mixed at the ratios shown in Table 1 to obtain a dispersion. The dispersion was applied onto a copper foil as an anode current collector and dried at 80° C. Thus, an anode current collector with a binder layer was obtained. The anode current collector with a binder layer includes an anode current collector and a binder layer formed on one main surface of the anode current collector.

### [1.2.2] Anode Mixture Layer

As the anode active material, an artificial graphite-based material having an amorphous coating with an average particle diameter of 15 μm was prepared. An anode active material, styrene-butadiene rubber (SBR) as a binder, carboxymethyl cellulose (CMC) as a thickener, and water as a dispersing solvent were mixed to obtain a slurry. The slurry was applied onto the binder layer of the anode current collector with binder layer to obtain an anode sheet. The anode sheet was punched using a punch of φ 12 (diameter: 12 mm) to obtain an anode. The anode is formed by laminating an anode current collector, a binder layer, and an anode mixture layer in this order. The capacitance of the anode is about 1.1 relative to the capacitance of the cathode.

### [1.2.3] Non-Aqueous Electrolyte Solution

To the mixed solvents, LiPF₆ as an electrolyte was added to obtain a non-aqueous electrolyte solution. The mixed solvents consist of ethylene carbonate (EC) and ethyl methyl carbonate (EMC). The volume ratio (EC: EMC) of EC to EMC was 30:70. LiPF₆ in the non-aqueous electrolyte solution was 1.0 M (mol/L).

### [1.2.4] Separator

As a separator, a porous film having a three-layer structure was prepared. The porous film is formed by laminating a polypropylene layer, a polyethylene layer, and a polypropylene layer in this order. The air permeability obtained by the Gurley test method of the porous membrane was 300 seconds.

### [1.2.5] Battery

A cell (electrode body) was formed using a cathode and an anode to face each other with a separator interposed therebetween, and the cell was sealed with a laminate together with a non-aqueous electrolyte solution, thereby producing an evaluation battery.

### [2] Evaluation

### [2.1] 1.0 C Rated Discharging Rate

### [2.1.1] Activation

In a 25° C. thermostatic chamber, the initial charge was performed using the constant current method, with a current value of 0. 1 C up to 4.30 V. Then, discharging was performed using the constant current method to 3.00 V at a current value of 0.3 C. This was repeated three times.

### [2.1.2] Initial Characterization

Charging was performed using the constant-current constant-voltage method to 4.30 V at a current value of 0.1 C, and constant voltage charging was performed to a point where the current at the time of constant voltage charging became 1/50 C, so that the fully charged state was obtained. Then, discharging was performed using the constant current method to 3.00 V at a current value of 0.2 C. The capacity at this time was defined as the initial capacity.

### [2.1.3] Evaluation of Long-Time I/O Characteristics

Charging was performed using the constant current method to 4.30 V at a current value of 0.1 C, and constant voltage charging was performed to a point where the current at the time of constant voltage charging became 1/50 C, so that the fully charged state was obtained. Then, discharging was performed using the constant current method to 3.00 V at a current value of 1.0 C. The volume at this time was measured.

The ratio of the capacitance measured by the long-time input/output characteristic to the initial capacitance measured by the initial characterization was defined as the “1.0 C rated discharging rate”. The measurement results are shown in Table 1. The acceptable 1.0 C rated discharging rate is “57% or more”.

### [2.2] Peel Strength

A peel test was performed to measure the peel strength of the anode mixture layer. Specifically, a prescribed tape was attached to the anode, and the stress when the tape was peeled off at a constant speed was measured. The stress when the anode mixture layer was peeled off was referred to as “peeling stress”. The measurement results are shown in Table 1. An acceptable extent of peel strength is “0.18 N/cm or greater.”

### [2.3] Formation of Composite Material

Evaluating methods of the material formation property were carried out according to JISK6854-11999. Specifically, the composite material formability (i.e., the binding properties necessary for producing the cells of Examples) was evaluated using the following evaluation criteria using the measurement results of the peel strength of the peel test. Evaluation results are given in Table 1. In order to fabricate the cell of the embodiment, a peel strength of 0.10 N/m² or more is obtained.

A: The peel strength was greater than or equal to 0.10 N/m^{2.}

B: The peel strength was less than 0.10 N/m^{2.}

### [2.4] Penetration Resistance

In order to evaluate the electronic conductivity between the anode mixture layer and the anode current collector (that is, the electronic conductivity of the anode), the penetration resistance was measured. Specifically, one terminal of the measurement device was electrically connected to the anode mixture layer of the anode, the other terminal of the measurement device was electrically connected to the anode current collector of the anode, and the anode mixture layer of the anode and the anode current collector of the anode were energized. The electronic resistance value between the terminals was referred to as “penetration resistance”.

The measurement results are shown in Table 1. The allowable penetration resistance is “2.10 Ω/cm or less”.

TABLE 1

| | Anode | | | | | | | | | | | |
|---|---|---|---|---|---|---|---|---|---|---|---|---|
| | | | | | | | Anode mixture | | | | | |
| | Binder layer | | | | | | layer | | Evaluation | | | |
| | | Conductive aid | | | | | Amount | | 1.0 C | | | |
| | | | Average | Amount | Thick- | | of | | rated | Formation | Anode | |
| | | | length | added | ness | | binder | Thick- | discharging | of | Peel | Penetration |
| | Binder | | (A) | % by | (B) | Ratio | % by | ness | rate | composite | strength | resistance |
| | Type | Type | μm | mass | μm | (A/B) | mass | μm | % | material | N/cm | Ω/cm |
| Comparative | — | — | — | 0 | 0 | 0 | 1.0 | 50 | 81 | A | 0.13 | 0.31 |
| Example 1 | | | | | | | | | | | | |
| Comparative | — | — | — | 0 | 0 | 0 | 1.0 | 100 | 78 | B | 0.08 | 0.35 |
| Example 2 | | | | | | | | | | | | |
| Comparative | — | — | — | 0 | 0 | 0 | 1.0 | 200 | 68 | B | 0.03 | 0.41 |
| Example 3 | | | | | | | | | | | | |
| Comparative | — | — | — | 0 | 0 | 0 | 2.0 | 100 | 68 | A | 0.15 | 0.24 |
| Example 4 | | | | | | | | | | | | |
| Comparative | — | — | — | 0 | 0 | 0 | 2.0 | 200 | 54 | B | 0.09 | 0.23 |
| Example 5 | | | | | | | | | | | | |
| Comparative | — | — | — | 0 | 0 | 0 | 3.0 | 100 | 52 | A | 0.31 | 0.22 |
| Example 6 | | | | | | | | | | | | |
| Comparative | — | — | — | 0 | 0 | 0 | 3.0 | 200 | 38 | A | 0.26 | 0.24 |
| Example 7 | | | | | | | | | | | | |
| Comparative | SBR | — | — | 0 | 5 | 0 | 1.0 | 100 | * | A | 0.31 | 34.00 |
| Example 8 | | | | | | | | | | | | |
| Example 1 | SBR | CNT | 15 | 0.5 | 5 | 3.0 | 1.0 | 100 | 68 | A | 0.34 | 1.20 |
| Example 2 | SBR | CNT | 15 | 1.0 | 5 | 3.0 | 1.0 | 100 | 76 | A | 0.28 | 0.31 |
| Example 3 | SBR | CNT | 15 | 2.0 | 5 | 3.0 | 1.0 | 100 | 77 | A | 0.25 | 0.26 |
| Comparative | SBR | — | — | 0 | 5 | 0 | 1.0 | 200 | * | A | 0.25 | 41.00 |
| Example 9 | | | | | | | | | | | | |
| Example 4 | SBR | CNT | 15 | 0.5 | 5 | 3.0 | 1.0 | 200 | 65 | A | 0.23 | 1.40 |
| Example 5 | SBR | CNT | 15 | 1.0 | 5 | 3.0 | 1.0 | 200 | 69 | A | 0.22 | 0.38 |
| Example 6 | SBR | CNT | 15 | 2.0 | 5 | 3.0 | 1.0 | 200 | 67 | A | 0.18 | 0.32 |
| Example 7 | SBR | CNT | 10 | 1.0 | 5 | 2.0 | 1.0 | 200 | 57 | A | 0.23 | 2.10 |
| Example 8 | SBR | CNT | 30 | 1.0 | 5 | 6.0 | 1.0 | 200 | 68 | A | 0.24 | 0.24 |
| Comparative | SBR | CNT | 10 | 1.0 | 10 | 1.0 | 1.0 | 200 | 54 | A | 0.38 | 2.30 |
| Example 10 | | | | | | | | | | | | |
| Comparative | SBR | CNT | 15 | 1.0 | 10 | 1.5 | 1.0 | 200 | 56 | A | 0.41 | 1.80 |
| Example 11 | | | | | | | | | | | | |
| Example 9 | SBR | CNT | 30 | 1.0 | 10 | 3.0 | 1.0 | 200 | 66 | A | 0.41 | 0.26 |
| Example 10 | PVdF | CNT | 15 | 1.0 | 5 | 3.0 | 1.0 | 100 | 77 | A | 0.38 | 0.28 |
| Example 11 | PVdF | CNT | 15 | 1.0 | 5 | 3.0 | 1.0 | 200 | 67 | A | 0.41 | 0.26 |

In Table 1, the “binder amount” indicates the ratio (% by mass) of the binder to the total amount of the anode mixture layer. “SBR” refers to styrene-butadiene rubber. “PVdF” refers to polyvinylidene fluoride. The “amount of the binder added” indicates a ratio (% by mass) of CNT to the total amount of the binder layers. “*” of 1.0 C rated discharging rate indicates that measurement is not possible.

In Comparative Example 1 to Comparative Example 11, the ratio (A/B) was not 1.8 or more. Therefore, the measured value of 1. 0 C rated discharging rate in Comparative Example 5 to Comparative Example 11 was not “57% or more”. The peel strength of Comparative Example 1 to Comparative Example 5 was not “0.18 N/cm or higher”. The penetration resistances of Comparative Example 8 to Comparative Example 10 were not “2.10 Ω/cm or less”.

As a result, it was found from Comparative Example 1 that the non-aqueous secondary battery of Comparative Example 11 was not a “non-aqueous secondary battery having excellent binding strength and electronic conductivity of the anode and suppressed deterioration in discharge rate characteristics”.

In Examples 1 to 11, the ratio (A/B) was 1.8 or more. Therefore, the measured value of 1. 0 C rated discharging rate in Example 1 to Example 11 was not “57% or more”. The peel strengths of Examples 1 to 11 were “0.18 N/cm or higher”. The penetration resistances of Examples 1 to 11 were “2.10 Ω/cm or less”.

As a result, it was found that the non-aqueous secondary batteries of Examples 1 to 11 were “non-aqueous secondary batteries having excellent binding strength and electronic conductivity of the anode and having suppressed deterioration in discharge rate characteristics”.

What is claimed is:

1. A non-aqueous secondary battery comprising:
a cathode;
an anode;
a separator disposed between the cathode and the anode; and
a non-aqueous electrolyte solution, wherein:
the anode is obtained by laminating an anode current collector, a binder layer, and an anode mixture layer in an order of the anode current collector, the binder layer, and the anode mixture layer;
the binder layer contains a conductive aid; and
a ratio of an average length of the conductive aid to an average thickness of the binder layer is 1.8 or more.

2. The non-aqueous secondary battery according to claim 1, wherein the ratio is 2.5 or more.

3. The non-aqueous secondary battery according to claim 2, wherein a content of the conductive aid is 0.8% by mass or more with respect to a total amount of the binder layer.

4. The non-aqueous secondary battery according to claim 3, wherein the binder layer includes a styrene-butadiene copolymer.

5. The non-aqueous secondary battery according to claim 1, wherein the anode mixture layer has a thickness of 100 μm or more.
